(19) United States
(12) Patent Application Publication
(10) Pub. No.: US 2013/0305140 A1
(43) Pub. Date: Nov. 14, 2013

(54) APPARATUS, SYSTEM, AND METHOD FOR OBTAINING IMAGE AND TEXT INFORMATION

(71) Applicant: TENCENT TECHNOLOGY (SHENZHEN) COMPANY LIMITED, Shenzhen (CN)

(72) Inventors: Shudong RUAN, Shenzhen (CN); Kaixiang ZHANG, Shenzhen (CN); Yu XU, Shenzhen (CN); Wei XIANG, Shenzhen (CN)

(73) Assignee: TENCENT TECHNOLOGY (SHENZHEN) COMPANY LIMITED

(21) Appl. No.: 13/941,498

(22) Filed: Jul. 14, 2013

Related U.S. Application Data
(63) Continuation of application No. PCT/CN2012/070525, filed on Jan. 18, 2012.

(30) Foreign Application Priority Data
Jan. 27, 2011 (CN) 201110032565.4

(51) Int. Cl. G06F 17/22

(52) U.S. Cl. CPC G06F 17/2247
USPC 715/234

(57) ABSTRACT

Various embodiments provide apparatus, systems, and methods for obtaining image and text information. In an exemplary method, an HTTP request can be sent to a web server based on URL information of the web server contained in a received HTTP request sent from a mobile terminal. HTML page information contained in a received HTTP response can be parsed to obtain image link information. An image HTTP request corresponding to the image link information can be sent to an image server. Image information returned from the image server can be received and packed with the HTML page information to form image and text information. The packed image and text information can then be sent to the mobile terminal that sends the HTTP request. In this manner, number of interactions between the mobile terminal and corresponding server(s) can thus be reduced.

### CROSS-REFERENCES TO RELATED APPLICATIONS

This application claims the priority to International Application No. PCT/CN2012/070525, filed on Jan. 18, 2012, which claims priority to Chinese Patent Application No. CN 201110032565.4, filed on Jan. 27, 2011, the entire contents of all of which are incorporated herein by reference.

### FIELD OF THE DISCLOSURE

The present disclosure relates to the field of information transmission technology and, more particularly, relates to an apparatus, system, and method for obtaining image and text information.

### BACKGROUND

With development of wireless Internet, obtaining information via wireless network has increasingly become an important part in people's life and work. Users may use a mobile terminal to connect to a server (such as a web server or an image server) through a wireless network, then use a wireless browser in the mobile terminal to send an HTTP (i.e., Hyper Text Transfer Protocol) request to the server to obtain image and text information including webpage text and images provided by the server.

FIG. 1 depicts a schematic flow diagram illustrating a current technology for a user to request and obtain image and text information. For example, when a user browses a webpage: http://www.foo.com/index.html, the webpage may include HTML (Hyper Text Mark-up Language) page information containing webpage text and image. The webpage content may include the following:

<html>
<body>
This is my foo Page
<img src=“http://image.foo.com/foo.jpg” />
</body>
</html>

In Step 101 of FIG. 1, a mobile terminal browser sends an HTTP request to a web server of a destination URL. The destination URL is http://www.foo.com/index.html and the web server has a domain name of www.foo.com.

In Step 102, the web server returns an HTTP response with HTML page information to the mobile terminal browser. The HTML page information includes:

<html>
<body>
This is my foo Page
<img src=“http://image.foo.com/foo.jpg”/>
</body>
</html>

In Step 103, the mobile terminal browser parses the received HTML page information, obtains image link information, and displays the webpage. Based on the received HTML page information, the mobile terminal browser displays a corresponding webpage text. Meanwhile, the mobile terminal browser parses image link information contained in the obtained HTML page information: http://image.foo.com/foo.jpg.

In practical operations, because webpage text information is contained in the HTML page information, the webpage text is directly obtained and displayed from the obtained HTML page information. However, images have to be obtained and displayed based on the image link information contained in the HTML page information after the HTML page information is obtained.

In Step 104, the mobile terminal browser sends an image HTTP request to an image server. The mobile terminal browser generates the image HTTP request based on the parsed and obtained image link information, sends the image HTTP request to the image server (contained in the image link information) to request for obtaining an image with a URL address: http://image.foo.com/foo.jpg. The image server has a domain name of image.foo.com, which is contained in the image link information.

In Step 105, the image server returns an image HTTP response to the mobile terminal browser. The image HTTP response, sent from the image server to the mobile terminal browser, contains binary image data, e.g., binary data for the image foo.jpg.

In Step 106, the mobile terminal browser adjusts the image according to the browser information and displays the adjusted image. The image server stores images in a unified format, and transmits images using the same format. Because mobile terminals may have different screen sizes, the mobile terminal browser needs to adjust the image size according to the browser information. For example, if a mobile terminal browser having a screen size of 600×450 needs to receive an image having a size of 800×600 (i.e., bigger than the screen size), the mobile terminal browser needs to adjust the image size to be about 600×450 and then displays the adjusted image.

Thus, current methods for a user to request and obtain image and text information require the mobile terminal browsers to send at least two HTTP requests for obtaining an image contained in a webpage. This involves too many times of interactions between the mobile terminal browser and a corresponding server. When a wireless network is relative slow, it requires too long time for obtaining image and text information, which affects users' browsing experiences. Meanwhile, the mobile terminal browser often has a screen size smaller than the size of the image transmitted by the image server. And thus the received image needs to be adjusted. This may result in resource waste during image transmission and may increase the time length used for transmitting image and text information.

### BRIEF SUMMARY OF THE DISCLOSURE

The disclosure provides apparatus, systems, and methods for obtaining image and text information with a reduced number of interactions between a mobile terminal browser and a corresponding server and with improved browsing experiences for users.

According to various embodiments, there is provided a proxy server including a Hyper Text Transfer Protocol (HTTP) request processing module, an HTTP fetching module, a Hyper Text Mark-up Language (HTML) parsing module, and a packaging module. The HTTP request processing module is configured to receive an HTTP request sent from a mobile terminal to obtain URL information of a web server contained in the HTTP request and to output the obtained URL information of the web server to the HTTP fetching module. The HTTP fetching module is configured, based on the received URL information of the web server, to fetch HTML page information from the web server corresponding to the URL information and to output the fetched HTML page information to the HTML parsing module; to receive image link information outputted from the HTML parsing module; to fetch image information from an image server corresponding to the image link information; and to output the fetched HTML page information and the image information to the packaging module. The HTML parsing module is configured to receive the HTML page information; to parse and obtain the contained image link information; and to output the image link information to the HTTP fetching module. The packaging module is configured to receive and pack the HTML page information and the image information and to output the packed HTML page information and the image information to the mobile terminal that sends the HTTP request.

According to various embodiments, there is also provided a system for obtaining image and text information. The system can include a mobile terminal, a proxy server, a web server, and an image server. The mobile terminal is configured to send an HTTP request to the proxy server and to receive, parse, and display the image and text information returned from the proxy server. The proxy server is configured to send the HTTP request to the web server based on URL information of the web server contained in the received HTTP request; to receive and parse an HTTP response containing HTML page information from the web server to obtain image link information; to send an image HTTP request corresponding to the image link information to an image server; to receive image information returned from the image server; and to pack the image information with the HTML page information into the image and text information and to output to the mobile terminal that sends the HTTP request. The web server is configured to obtain the corresponding HTML page information based on the URL information in the received HTTP request and to contain the HTML page information in the HTTP response and send to the proxy server. The image server is configured to obtain image information based on the image link information in the received image HTTP request and to contain the image information in an image HTTP response and send to the proxy server.

According to various embodiments, there is further provided a method for obtaining image and text information. In the method, an HTTP request is sent to a web server based on URL information of the web server contained in a received HTTP request sent from a mobile terminal. HTML page information contained in a received HTTP response is parsed. Image link information is obtained and an image HTTP request is sent to an image server corresponding to the image link information. Image information returned from the image server is received and packed with the HTML page information to form image and text information. The packed image and text information can then be sent to the mobile terminal that sends the HTTP request.

According to various embodiments, there is further provided a method for obtaining image and text information by a proxy server. In this method, an HTTP request sent from a mobile terminal can be received and URL information of a web server contained in the HTTP request can be obtained. Based on the URL information of the web server, HTML page information can be fetched from the web server corresponding to the URL information. Image link information can be received. Corresponding to the image link information, image information from an image server can be fetched. The HTML page information and the image information can be packed and outputted to the mobile terminal that sends the HTTP request.

According to various embodiments, there is further provided a computer readable medium containing executable computer instructions for performing a method for obtaining image and text information in a proxy server. An HTTP request sent from a mobile terminal can be received and URL information of a web server contained in the HTTP request can be obtained. Based on the URL information of the web server, HTML page information can be fetched from the web server corresponding to the URL information. Image link information can be received. Corresponding to the image link information, image information from an image server can be fetched. The HTML page information and the image information can be packed and outputted to the mobile terminal that sends the HTTP request.

The disclosed apparatus, systems, and methods for obtaining image and text information allow the mobile terminal to obtain all resources for displaying a webpage by sending one HTTP request (instead of multiple requests). This reduces the number of interactions between the mobile terminal and corresponding server(s), increases speed for displaying the webpage on the mobile terminal, and improves experiences on using the mobile terminal.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples according to the disclosed embodiments.

FIG. 1 depicts a schematic flow diagram of a conventional method for obtaining image and text information;

FIG. 2 depicts an exemplary system for obtaining image and text information in accordance with various disclosed embodiments;

FIG. 3 depicts an exemplary proxy server for obtaining image and text information in accordance with various disclosed embodiments; and

FIG. 4 depicts an exemplary method for obtaining image and text information in accordance with various disclosed embodiments.

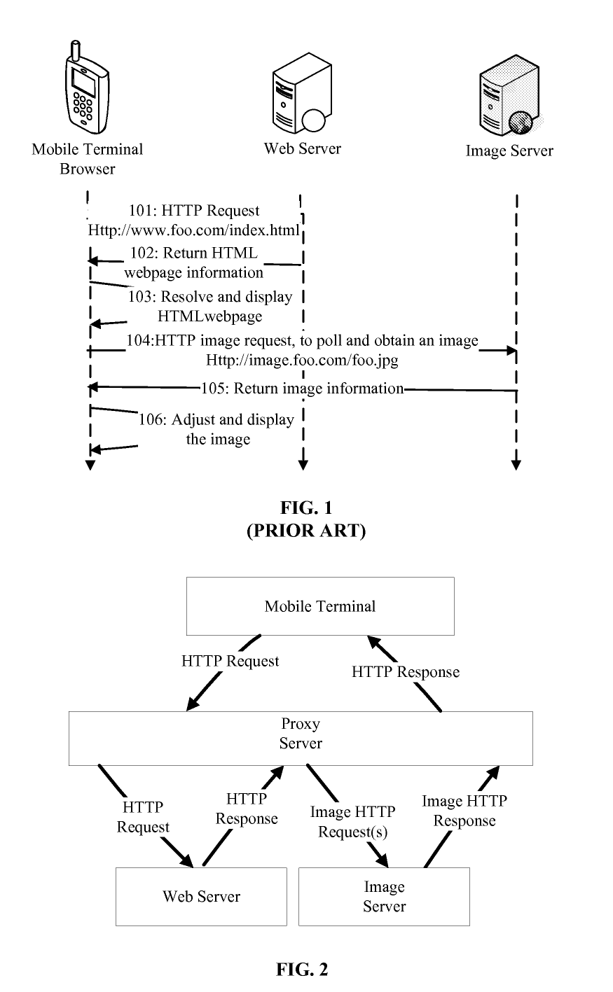

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

To obtain image and text information, a mobile terminal browser needs to send an HTTP request to a web server to obtain HTML page information, to parse the obtained HTML page information, and to obtain image link information contained therein. Based on the obtained image link information, the mobile terminal browser sends an image HTTP request to an image server to obtain a corresponding image and then to display. The mobile terminal browser is thus required to send at least two HTTP requests in order to obtain image and text information in a webpage, which requires a long time to process.

As disclosed herein, a proxy server is introduced to a server side and configured to imitate interactions between a mobile terminal browser and a web server (and/or an image server) to obtain, pack, and output image and text information to the mobile terminal browser. This can effectively reduce over-the-air transmission delay as conventionally occurred when the mobile terminal browser sends the image HTTP request to the image server.

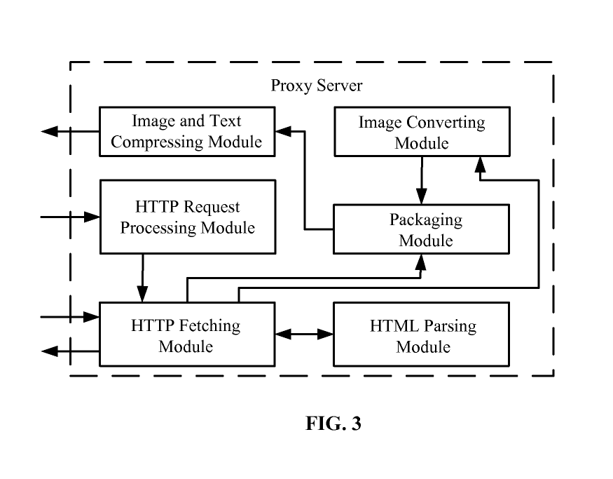

FIG. 2 depicts an exemplary system for obtaining image and text information in accordance with various embodiments. The exemplary system depicted in FIG. 2 includes a mobile terminal, a proxy server, a web server, and/or an image server.

The mobile terminal is configured to send an HTTP request to the proxy server, and to receive, parse, and display image and text information returned from the proxy server. The HTTP request contains URL information of the web server. For example, if a user wants to browse a webpage of http://www.foo.com/index.html, the URL information of the web server is http://www.foo.com/index.html. The web server domain name may be contained in the URL information. In this example, the domain name of the web server is www.foo.com.

In an exemplary embodiment, the HTTP request sent from the mobile terminal to the proxy server further contains browser information of the mobile terminal. The mobile terminal can retrieve browser information by calling related functions. In some cases when multiple mobile terminals are used to send HTTP requests to one proxy server, each HTTP request can be differentiated by containing a corresponding mobile terminal identity (ID).

The proxy server is configured: to send the HTTP request to the web server, based on the URL information of the web server contained in the received HTTP request; to receive and parse an HTTP response that contains HTML page information sent from the web server; to obtain image link information and to send an image HTTP request corresponding to the image link information to an image server; to receive image information returned from the image server; and to pack image information with the HTML page information into image and text information, and to output the image and text information to the mobile terminal that sends or initiates the HTTP request.

For example, the proxy server obtains the HTML page information by interacting with the web server, and obtains image information by interacting with the image server. The proxy server then packs the HTML page information with the image information and sends the packed image and text information to the mobile terminal. In this manner, the over-the-air transmission time can be saved between the mobile terminal and the image server (e.g., the interaction is instead between the proxy server and the image server). The browsing experiences for users can then be improved.

As mentioned above, if the HTTP request sent from the mobile terminal to the proxy server contains the browser information of the mobile terminal, the proxy server can further process image information based on the browser information of the mobile terminal and then pack the processed image together with the HTML page information to generate the image and text information.

For example, if the obtained image size is about 800×600 while the mobile terminal browser screen size is about 600×450, the proxy server can adjust the obtained image size to be about 600×450 to substantially fit the screen size of the mobile terminal browser. Any suitable packing processes can be used herein.

Of course, in practical applications, the packed image and text information can further be compressed in some cases. This can effectively reduce usage of the transmission resources and reduce transmission time of the image and text information.

The web server is configured to obtain the HTML page information corresponding to the URL information contained in the received HTTP request; to contain the HTML page information in the HTTP response; and to send the HTTP response to the proxy server.

The image server is configured to obtain corresponding image information based on the image link information contained in the received image HTTP request; to contain the image information in the image HTTP response; and to send the image HTTP response to the proxy server. In various embodiments, the proxy server can be configured in any manner, e.g., as a relatively “independent” device or can be integrated with other device(s), e.g., the web server, in the system.

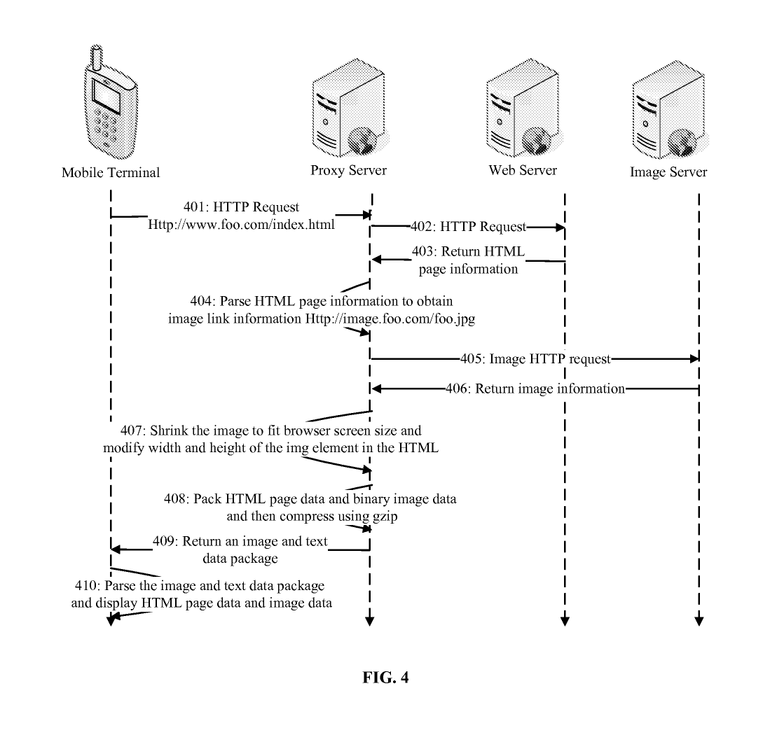

FIG. 3 depicts an exemplary proxy server in accordance with various disclosed embodiments. For example, the exemplary proxy server depicted in FIG. 3 may include an HTTP request processing module, an HTTP fetching module, an HTML parsing module, and/or a packaging module.

The HTTP request processing module is configured to receive an HTTP request sent from a mobile terminal; to obtain URL information of a web server contained in the HTTP request; and to output the obtained URL information of the web server to the HTTP fetching module.

The HTTP fetching module is configured to fetch HTML page information from the web server corresponding to the received URL information of the web server; to output the HTML page information to the HTML parsing module; to receive image link information outputted from the HTML parsing module; to fetch image information corresponding to the image link information from an image server, and to output the fetched HTML page information and the image information to the packaging module.

The HTML parsing module is configured to receive the HTML page information; to parse the image link information contained in the HTML page information; and to output the image link information to the HTTP fetching module.

The packaging module is configured to receive the HTML page information and the image information; to pack the HTML page information with the image information; and to send the packed image and text information to the mobile terminal that sends the HTTP request.

In an exemplary embodiment, the HTTP request processing module is further configured to parse the received HTTP request; and to output browser information of the mobile terminal contained in the HTTP request to an image converting module. Optionally, the proxy server further includes an image converting module. The image converting module is configured to read the image information from the HTTP fetching module; to covert an image based on the received browser information (e.g., screen size) of the mobile terminal; and to output the converted image to the packaging module.

In practical operations, optionally, the proxy server can also include an image and text compressing module. The image and text compressing module is configured to compress the packed image and text information packed by the packaging module and to output the compressed image and text information to the mobile terminal.

In this manner, the exemplary system for obtaining image and text information can receive an HTTP request from a mobile terminal using a proxy server and can send the HTTP request to a web server based on URL information of the web server contained in the received HTTP request. The proxy server can receive and parse an HTTP response that contains HTML page information from the web server; obtain image link information; send an image HTTP request to an image server; and receive image information from the image server. The proxy server can pack the image information together with the HTML page information into image and text information and send the packed image and text information to the mobile terminal.

As such, the mobile terminal browser only needs to send one HTTP request and all resources (e.g., the HTML page information and the image information) for displaying a webpage can be obtained. This can save number of requests of the HTTP request and reduce number of interactions between the mobile terminal browser and corresponding server(s). As wireless network is often relatively slow, saving the number for HTTP request(s) can save time for obtaining image and text information and thus improve browsing experiences for users. Further, the proxy server can adjust image sizes (e.g., shrink or enlarge) as desired based on the browser information of the mobile terminal. This may, e.g., significantly decrease the package size of the image and text data package and saves resources for transmission. Furthermore, the proxy server can compress the image and text information, for example, by packing the HTML page information (or data) with the image information (or data) and using gzip to compress the packed HTML page data and image data. The package size of the image and text data package can be further decreased.

FIG. 4 depicts an exemplary method for obtaining image and text information in accordance with various disclosed embodiments. Note that although the exemplary method depicted in FIG. 4 uses an example where a user browses webpage of http://www.foo.com/index.html containing webpage text and image, the method depicted herein is not limited by this example, any other suitable webpages for browsing can be encompassed.

In 401, an HTTP request may be received, e.g., by a proxy server, from a mobile terminal. In 402, the HTTP request is then sent, e.g., by the proxy server, to a web server based on URL information of the web server contained in the received HTTP request. For example, the proxy server may send the HTTP request to the web server having a destination URL http://www.foo.com/index.html. The web server has a domain name www.foo.com.

In 403, the proxy server receives an HTTP response from the web server and obtains HTML page information. For example, the web server returns the HTTP response to the proxy server, and the proxy server obtains HTML page information as follows.

<html>
<body>
This is my foo Page
<img src=“http://image.foo.com/foo.jpg” width=“800” height=“600” />
</body>
</html>

In 404, the proxy server parses the HTML page information to obtain image link information. For example, the proxy server may parse HTML page information to obtain image URL in an img element, e.g., to obtain image link information: http://image.foo.com/foo.jpg. The HTML page information may include WML (wireless markup language) page information and XHTML (eXtensible Hyper Text Markup Language) page information.

In 405, the proxy server sends image HTTP request to an image server. For example, the proxy server may send an image HTTP request (http://image.foo.com/foo.jpg) to the image server. The image server may have a domain name: image.foo.com.

In practical operations, when multiple-image-link information is required to be obtained, multiple image HTTP requests or one image HTTP request containing multiple-image-link information may be sent, for example, from the proxy server to the image server. In this manner, number of interactions between the proxy server and the image server can be effectively reduced.

In 406, the proxy server receives image information returned from the image server. For example, the returned image information may include a binary image data of foo.jpg.

In 407, optionally, the proxy server processes the image based on pre-obtained browser information of the mobile terminal. For example, this process may be conducted when the HTTP request(s) sent from the mobile terminal to the proxy server contains the browser information of the mobile terminal.

In various embodiments, assuming an original image has a size of about 800×600 while the mobile terminal browser has a height/width (e.g., contained in the browser information of the mobile terminal) of about 180×240, the original image cannot be displayed on the mobile terminal. However, the disclosed proxy server may shrink the original image to convert the image to be about 180×240 according to the browser/screen size of the mobile terminal. The disclosed proxy server may also set the height/width as 180/240 in an img element. For example, corresponding source code can be as follows:

<html>
<body>
This is my foo Page
<img src=“http://image.foo.com/foo.jpg” width=“240” height=“180” />
</body>
</html>

In 408, the proxy server packs the image information with the HTML page information for form the image and text information. For example, the proxy server may pack HTML page data with image data. The proxy server may further perform gzip compression and then return to the mobile terminal. Any suitable algorithm for data compression can be included herein.

In 409, the proxy server returns an image and text data package to the mobile terminal. For example, the image and text data package can be the packed image and text information as disclosed herein.

In 410, the mobile terminal receives, parses, and displays the image and text information. For example, the mobile terminal browser parses the image and text data package to obtain the HTML page data and the image data, which are then displayed, e.g., in certain order.

In various embodiments, the mobile terminal, the proxy server, the web server, and/or the image server disclosed herein may be implemented on any appropriate computing platform. For example, such computer system may include a processor, a storage medium, a monitor, a communication module, a database, peripherals, and/or one or more bus to couple the devices together.

The processor may include any appropriate processor or processors and can include multiple cores for multi-thread or parallel processing. The storage medium may include memory modules, such as ROM, RAM, and flash memory modules, and mass storages, such as CD-ROM, U-disk, removable hard disk, etc. The storage medium may store computer programs for implementing various processes, when executed by processor.

For example, various embodiments can include a computer readable medium containing executable computer instructions for performing the methods provided herein for obtaining image and text information, e.g., in a proxy server. An HTTP request sent from a mobile terminal can be received and URL information of a web server contained in the HTTP request can be obtained. Based on the URL information of the web server, HTML page information can be fetched from the web server corresponding to the URL information. Image link information can be received. Corresponding to the image link information, image information from an image server can be fetched. The HTML page information and the image information can be packed and outputted to the mobile terminal that sends the HTTP request.

The peripherals may include I/O devices such as keyboard and mouse, and the communication module may include network devices for establishing connections through a communication network such as a wireless Internet. The database may include one or more databases for storing certain data and for performing certain operations on the stored data, such as webpage browsing, database searching, etc.

The embodiments disclosed herein are examples only. Other applications, advantages, alternations, modifications, or equivalents to the disclosed embodiments are obvious to those skilled in the art.

What is claimed is:

1. A proxy server comprising:
a Hyper Text Transfer Protocol (HTTP) request processing module, an HTTP fetching module, a Hyper Text Mark-up Language (HTML) parsing module, and a packaging module, wherein:
the HTTP request processing module is configured to receive an HTTP request sent from a mobile terminal to obtain URL information of a web server contained in the HTTP request and to output the obtained URL information of the web server to the HTTP fetching module;
the HTTP fetching module is configured, based on the received URL information of the web server, to fetch HTML page information from the web server corresponding to the URL information and to output the fetched HTML page information to the HTML parsing module; to receive image link information outputted from the HTML parsing module; to fetch image information from an image server corresponding to the image link information;
and to output the fetched HTML page information and the image information to the packaging module;
the HTML parsing module is configured to receive the HTML page information; to parse and obtain the contained image link information; and to output the image link information to the HTTP fetching module; and
the packaging module is configured to receive and pack the HTML page information and the image information and to output the packed HTML page information and the image information to the mobile terminal that sends the HTTP request.

2. The proxy server of claim 1, further comprising an image converting module, wherein the HTTP request processing module is further configured to output browser information of the mobile terminal, contained in a parsed and obtained HTTP request, to the image converting module; and wherein the image converting module is configured to read the image information from the HTTP fetching module, to process an image conversion based on the received browser information of the mobile terminal, and to output to the packaging module.

3. The proxy server of claim 1, further comprising an image and text compressing module configured to compress the image and text information packed by the packaging module and to output to the mobile terminal that sends the HTTP request.

4. The proxy server of claim 2, further comprising an image and text compressing module configured to compress the image and text information packed by the packaging module and to output to the mobile terminal that sends the HTTP request.

5. A system for obtaining image and text information comprising:
a proxy server, a web server, and an image server, wherein:
the proxy server is configured to send an HTTP request to the web server based on URL information of the web server contained in the received HTTP request; to receive and parse an HTTP response containing HTML page information from the web server to obtain image link information; to send an image HTTP request to an image server corresponding to the image link information; to receive image information returned from the image server; and to pack the image information with the HTML page information into the image and text information and to output to a mobile terminal that sends the HTTP request for the mobile terminal to parse and display the image and text information;
the web server is configured to obtain the corresponding HTML page information based on the URL information in the received HTTP request and to contain the HTML page information in the HTTP response and send to the proxy server; and
the image server is configured to obtain image information based on the image link information in the received image HTTP request and to contain the image information in an image HTTP response and send to the proxy server.

6. The system of claim 5, wherein the proxy server comprises an HTTP request processing module, an HTTP fetching module, an HTML parsing module, and a packaging module, and wherein:
the HTTP request processing module is configured to receive the HTTP request from the mobile terminal and to obtain the URL information of the web server contained in the HTTP request and output to the HTTP fetching module;
the HTTP fetching module is configured to fetch the HTML page information from the web server based on the received URL information of the web server and output to the HTML parsing module; to receive the image link information outputted from the HTML parsing module; to fetch the image information from the image server corresponding to the image link information, and to output the fetched HTML page information and the image information to the packaging module;
the HTML parsing module is configured to receive the HTML page information; to obtain the image link information contained in the HTML page information; and to output the image link information to the HTTP fetching module; and
the packaging module is configured to receive and pack the HTML page information and the image information and send to the mobile terminal that sends the HTTP request.

7. The system of claim 6, wherein the proxy server further comprises an image converting module, wherein the HTTP request processing module is further configured to output browser information of the mobile terminal, contained in a parsed and obtained HTTP request, to the image converting module; and wherein the image converting module is configured to read the image information from the HTTP fetching module, to process an image conversion based on the received browser information of the mobile terminal, and to output to the packaging module.

8. The system of claim 6, wherein the proxy server further comprises an image and text compressing module configured to compress the image and text information packed by the packaging module and output to the mobile terminal that sends the HTTP request.

9. The system of claim 7, wherein the proxy server further comprises an image and text compressing module configured to compress the image and text information packed by the packaging module and output to the mobile terminal that sends the HTTP request.

10. A method for obtaining image and text information comprising:
sending an HTTP request to a web server based on URL information of the web server contained in a received HTTP request sent from a mobile terminal;
parsing HTML page information contained in a received HTTP response to obtain image link information;
sending an image HTTP request to an image server corresponding to the image link information;
receiving image information returned from the image server to pack the image information with the HTML page information into image and text information; and
sending the packed image and text information to the mobile terminal that sends the HTTP request.

11. The method of claim 10, wherein the HTTP request further contains browser information of the mobile terminal and wherein the receiving of the image information returned from the image server to pack the image information with the HTML page information into the image and text information comprises:
receiving the image information returned from the image server and processing image based on the browser information of the mobile terminal; and
packing the processed image and the obtained HTML page information into the image and text information.

12. The method of claim 10, further comprising compressing the packed image and text information after the image and text information is packed and before the packed image and text information is sent to the mobile terminal that sends the HTTP request.

13. The method of claim 11, further comprising compressing the packed image and text information after the image and text information is packed and before the packed image and text information is sent to the mobile terminal that sends the HTTP request.

14. A method for obtaining image and text information by a proxy server, the method comprising:
receiving an HTTP request sent from a mobile terminal to obtain URL information of a web server contained in the HTTP request;
based on the URL information of the web server, fetching HTML page information from the web server corresponding to the URL information;
receiving image link information;
fetching image information from an image server corresponding to the image link information; and
packing the HTML page information and the image information and outputting the packed HTML page information and the image information to the mobile terminal that sends the HTTP request.

15. The method of claim 14, further comprising:
outputting browser information of the mobile terminal contained in a parsed and obtained HTTP request;
reading the image information; and
processing an image conversion based on the received browser information of the mobile terminal.

16. The method of claim 14, further comprising:
compressing the image and text information that is packed; and
outputting the image and text information to the mobile terminal that sends the HTTP request.

17. The method of claim 15, further comprising:
compressing the image and text information that is packed; and
outputting the image and text information to the mobile terminal that sends the HTTP request.

18. A computer readable medium containing executable computer instructions for performing a method for obtaining image and text information in a proxy server, the method comprising:
receiving an HTTP request sent from a mobile terminal to obtain URL information of a web server contained in the HTTP request;
based on the URL information of the web server, fetching HTML page information from the web server corresponding to the URL information;
receiving image link information;
fetching image information from an image server corresponding to the image link information; and
packing the HTML page information and the image information and outputting the packed HTML page information and the image information to the mobile terminal that sends the HTTP request.

19. The medium of claim 18, wherein browser information of the mobile terminal is contained in a parsed and obtained HTTP request, and wherein the image information is read and an image conversion is processed based on the received browser information of the mobile terminal.

20. The medium of claim 18, wherein the image and text information is packed, compressed, and outputted to the mobile terminal that sends the HTTP request.
